(19) United States
(12) Patent Application Publication
(10) Pub. No.: US 2023/0264277 A1
(43) Pub. Date: Aug. 24, 2023

(54) HORIZONTAL MULTI DIAMOND WIRE SAW CUTTING MACHINE

(71) Applicant: Yousuf MUQAIBIL, Salalah (OM)

(72) Inventor: Yousuf MUQAIBIL, Salalah (OM)

(21) Appl. No.: 18/024,038

(22) PCT Filed: Aug. 31, 2020
(86) PCT No.: PCT/OM2020/050006

§ 371 Date: Feb. 28, 2023

(51) Int. Cl. B23D 57/00; B28D 1/08

(52) U.S. Cl. CPC B23D 57/0053; B28D 1/08; B23D 57/0092; B23D 57/0069

(57) ABSTRACT

A horizontal multi diamond wire saw cutting machine in a closed loop running in a coaxial motion toward stone blocks allowing a cutting force direction to each other, the cutting direction of DW is in horizontal motion-whether stone blocks toward machine or machine running toward blocks- and tension system made of one tension pulley because of one DW running within machine, in addition the running of DW is by several drive wheels, set of drive wheels run by one shaft in clockwise motion, another set run by another shaft in counter clockwise motion. Each drive wheel supported by sprag clutch which allow pulling DW for the cutting speed and allow DW to be tensioned in all drive wheels by one tensioned pulley which is tightened by linear stroke by a jack with a set tension value. Further, a portable machine to be held within block and cutting execution.

### TECHNICAL FIELD

The present invention relates to designing a machine for cutting stones using diamond wire saws in horizontal array in close loop and, more particularly, multiple diamond wires running in coaxial motion with an improved structure capable of cutting various rigid or super rigid materials.

### BACKGROUND ART

Multi wire saw Machine are identical design too, they are composed of all mentioned components above except that several rings of DW run by single drive wheel (drum) and two drums of guide wheels positioning precise in-out motion, separate pulleys with adjustable tension for each wire.

Multi wire saw machine design made of different constructions to meet the cutting dimension of Maximum standard stone blocks with size of 3.2 m×2 m×2 m. Construction made of 2/4 columns with high of about 6-7 m, 13-14 m in length and width varies according to the No wires it handle.

DW tension is operated independently because of separate DW rings. Machine suppliers keep on developing their product to meet the high performance and they meet required efficiency in operation.

The only limitation is the complexity in design and high investment on making the construction design which to raise cost on machine user on the initial investment and maintenance cost. a wire saw composed of sintered metal bonded diamond beads, wherein countless such diamond beads, each formed with a through hole, are stringed together by a pliable yet strong cord. This type of wire saw is disadvantaged by its relatively large cord diameter, which leads to a kerf typically more than 1 mm in width. In addition, this type of wire saw is also unmanageable when operated along curved cutting paths with small radii of curvature and incurs a considerable production cost.

### SUMMARY OF INVENTION

In view that the shortcomings of the prior art require immediate improvement, the inventor of the present invention, based on more than 10 years of experience in the related industry, strived to figure out ways to make a wire saw machine for cutting stones of different types which is giving more production capacity with less maintenance down time, incurs a low manufacturing cost. Which reduces the material wastage and ease of performing operation with improved safety. After repeated experiments and extensive research, the inventor finally succeeded in designing and developing a Multi diamond wire saw machine with an improved structure.

The disclosed Diamond wire saw machine features,
1. Mini Portable multi-wire saw plant for cutting natural stone or semi products.
2. Mini plant would use the available stone quarry machines/facilities.
3. New small, simple design structure and easy in operation.
4. Multi section cutting in horizontal motion by one close loop DW/several closed loops DW.
5. One DW tension system to run the machine.
6. DW running in horizontal cutting motion by two drive wheels sets.
7. DW running in coaxial motion.
8. Each dive wheel contains a sprag clutch (one way bearing for one closed loop DW model).
9. Easy change of DW since it is a single wire (for one spiral closed loop DW).

All above allow simple structure design or possibility to make portable cutting machine beside stone mines to cut off transportation cost as stone block.

### Technical Problem

Existing vertical DW cutting machines produce a large amount of material wastage and the bottom layer of the stone block cannot be recovered and extremely difficult and unsafe to unload the cut out slabs. Without individual tensioning mechanism the cutting quality is being affected unreasonably.

Consequently, setting up plant away from the quarry tend to higher mobilization cost, since around (25-35) % of the material turned to waste powder form by sawing meaning. In addition, loading/unloading by meaning of gantry crane, water reclamation plant and factory construction civil work cost is additional cost to any natural stone project to make at least unpolished slabs products.

### Solution to Problem

Machine with a new design to allow one DW in a closed loop running in a coaxial motion toward stone blocks allowing a cutting force direction to each other, the cutting direction of DW is in horizontal motion-whether stone blocks toward machine or machine running toward blocks- and tension system made of one tension pulley because of one DW running within machine, in addition the running of DW is by several drive wheels, set of drive wheels run by one shaft in clockwise motion, another set run by another shaft in counter clockwise motion. Each drive wheel supported by sprag clutch (one way bearing) which allow pulling DW for the cutting speed and allow DW to be tensioned in all drive wheels by one tensioned pulley which is tightened by mean of linear stroke by a jack (hydraulic, mechanic, pneumatic) with a set value of tension kg unit. In addition, a way of portable machine to be hold within block and execution of cutting to be done.

### Advantageous Effects of Invention

Here the invention is the new machine designed by the inventor. A study has been conducted by the inventor comparing salient features of our WSM design and other existing machines in market. First of all, the no of machines, which are using multiwires in horizontal cutting is very few, as of this concept and idea is very fresh to be implemented. Apart from vertical cutting there are a lot of advantages are there in horizontal cutting like, reduced material wastage safer operations and easy material handling after production, etc.

This Horizontal Multi-wire saw machine has following features which stands out from the other manufacturers,

The Machine is designed as a portable machine, to be used in quarry or workshops, where it can be moved from one site to another with very limited change over time This machine has been designed with individual wire tensioning; most of the other machines in market are having mono tensioning system.

We have been checking with existing manufacturer like SKYSTONE, PEDRINI, GASPARI-MENOTTI, UNIVERSO, BIDESE, PELLEGRINI and we have been convinced as our designs meets all the necessary features that all the similar machines have.

Based on the concept of maximizing the wires performance, the new design optimizes wires performance and reduces comprehensive cost. Repair and maintenance cost: outstanding structure design allows customers get quick and easy maintenance. Additionally our excellent protection design and practice have proved that we can bring lowest cost in maintenance to our clients

Set-up: very easy and fast. Within 1 day of set-up, machine can start operation

### BRIEF DESCRIPTION OF DRAWINGS

FIG. 1

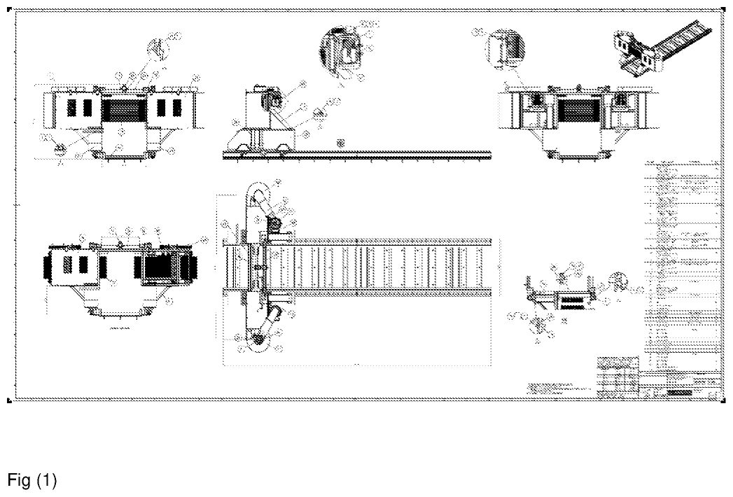

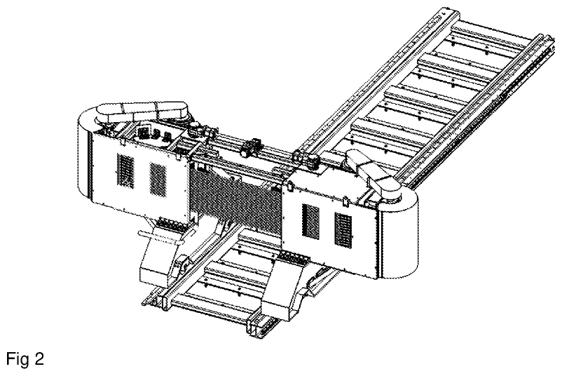

Drawing shown in FIG. 1 is the main structural assembly drawing of the entire machine with three planar views and one 3D isometric view. The components which the drawing comprises are mentioned below.
Machine Has 2×100 HP motor on Both side for Driving Saw Wire
And 1×3 HP for machine Movement
And 7 Hp water pump for coolant water
Rack and pinion Gear system for machine movement.
Easy to open covers for maintenance
Independent tension system for wire tension.
Wire Guide Rollers to get each slab at perfect thickness.
Length:12000 MM
Width:7000 MM
Overall Height: 3200 MM
Cutting Area length:12000 MM
Cutting Area Width:1850 MM
Cutting Area Height: 1000 MM

FIG. (2)

FIG. A-Model for separates closed loop DW around cutting object (below)

### DESCRIPTION OF EMBODIMENTS

The present invention is done description in more detail below in conjunction with accompanying drawing: In conjunction with FIG. 1, the Multiwire saw machine comprises of, 1.guided railing system assembled and fixed to the floor by ground bolts, 2. rack and pinion dual drive system with drive motor and heavy duty bearing assisted wheels on both sides of the rail guide system, 3. Heavy duty structural gantry assembly connecting the dual drive units and housing the, 4. wire driving drum connected to the electrical motor through belt drive system and 5. tension pully driving unit with pneumatic cylinder assemblies. 6. Cooling water system with pumping unit and spray nozzle manifold. 7. Plc controlled electrical control panel.

Although this invention is described in terms of specific embodiments, it is not limited thereto, as would be understood by those skilled in the art, numerous variations are possible wherein the scope of the invention, without departing from the spirit and nature thereof.

### Examples

### INDUSTRIAL APPLICABILITY

The size of the machine will be 12 m×7 m×3.2 m. The machine will be able to produce 32 Slide Per turn
Variable speed control for machine movement come in handy.
Ideal for stone, marble, Granite Cutting.
Designed for high rate of cutting.
Designed to cut each slab with same thickness.
Designed that Comes with emergency stop and Coolant water spray.
Working of machine is horizontal for easy handling
Designed in such away as it is Simple to use and operate.

### REFERENCE SIGNS LIST

WSM-Wire Saw Machine
DW-Diamond Wire

### CITATION LIST

| Publication number | Publication date | Title |
|---|---|---|
| CN101859122A | 2010 Oct. 13 | Automatic electrical control |
| system for wire saw machine | | |
| CN101982276A | 2011 Mar. 2 | Cutting machine in underwater |
| pipeline | | |
| CN102229009A | 2011 Nov. 2 | Variable structure adaptive feed |
| type rope saw | | |
| CN103600429A | 2014 Feb. 26 | Driving device of rope sawing |
| machine | | |
| WO2014106081A1 | 2014 Jul. 31 | Diamond, LlcSawing system, |

sawing support structure and a wire replacement unit and method

| | | |
|---|---|---|
| US4832411A | 1989 May 12 | Method and apparatus for cutting |
| reinforced concrete | | |
| US4893607A | 1990 Jan. 10 | Wire drive apparatus for wire saw |
| US5173250A | 1992 Dec. 22 | Apparatus for demolishing |

biological shield wall of a nuclear reactor and a method of demolishing the same

| | | |
|---|---|---|
| US5193518A | 1993 Mar. 16 | Portable wire saw |

### PATENT LITERATURE

The WSM Machine invention has been carried out in 3 phases as briefed below after an year long observations, group discussions, studies and analysis of actual worksite procedures and difficulties by the inventor and the research team
Phase 1-3D Design, Material and Component Selection
   Creating subassemblies and consolidating all parts and creating final assembly
   Remodeling all needed parts to make them compatible for fabrication
   Identifying all standard parts and parts that should be fabricated
   Applying material grade and machining tolerances for each parts and adding welding grade and standards
   Selection of fasteners and preparing list and tensioning load data selection
   Making final intelligent assemblies and subassemblies drawings and simulation
      3D Detailed Design along with component selection
Phase 2—Drawing and Bom Making
   Provide components shop drawings/fabrication drawings
   Provide BOM, Hole table/Weldment cut list of both fabricated parts and standard components with supplier reference
      Drawings
Phase 3—analysis And Electrical drawings
   Analysis of subassemblies and assemblies with machine safety standards
   Electrical/electronic/control system design, prepare BOM and Wiring diagram
   Provide lubrication system and cooling system design maintenance guideline notes
   Provide overall machine design review and simulation

### Non Patent Literature

Publication Publication Date Title
US6085448A2000-07-11Device for excavating an elongated depression in soil
US3323507A1967-06-06Concrete cutting machine
US4542940A1985-09-24Method and apparatus for cutting a trench through rock-like material
CA1235151 A1988-04-12Rotary rock and trench cutting saw
JP3462213B22003-11-05Drilling tool and drilling device having the same
JP2005083014A2005-03-31Pre-cast tunnel method and member conveyor used therefor
CN100453746C2009-01-21Cutter and method for working the soil
JP3761889822006-03-29Method for forming groove wall on ground, groove wall cutter
US20090293856A12009-12-03Underwater diamond wire saw assembly
US4778304A1988-10-18Pavement joint reworking apparatus
US200701267006A12007-11-22Wire Saw Machine
WO2013175647A12013-11-28Hydraulic shovel
US4230372A1980-10-28Dual rock cutter wheel trencher
US4852946A1989-08-01Surface working accessory and method
JP2009062808A2009-03-26Foundation construction device for producing trench in soil
US2795222A1957-06-11Wire stone sawing machine

1. A horizontal diamond wire saw cutting machine comprising:
multiple diamond wire saw elements, each being configured to operate in a closed loop run in;
a direction towards another of the diamond wire saw elements each other; and
in a different elevation and in parallel to the closed loop run of the other of the diamond saw elements:
wherein:
the closed loop run of each of the diamond wire saw elements operates with a separate tension pulleys and a separate drive wheel running in rotation opposite to that of the other of the diamond wire saw elements; and
each drive wheel operates with a clutch bearing to allow cutting in one direction and free motion to another direction for tensioning the cutting tools with tension pulley or tensioning a set of drive wheel.

2. The horizontal diamond wire saw cutting machine, further being configured for cutting stone in a quarry.
